(19) United States
(12) Patent Application Publication
(10) Pub. No.: US 2006/0278842 A1
(43) Pub. Date: Dec. 14, 2006

(54) High water-containing electrolytic solution for electrolytic capacitor

(76) Inventor: Kun-Li Wang, Taichung (TW)

Correspondence Address: HDSL, 4331 STEVENS BATTLE LANE, FAIRFAX, VA, 22033, US

(21) Appl. No.: 11/228,271

(22) Filed: Sep. 19, 2005

(30) Foreign Application Priority Data
Jun. 9, 2005 (TW) 94119098

(51) Int. Cl. H01G 9/02

(52) U.S. Cl. 252/62.2

(57) ABSTRACT

A high water-containing electrolyte with higher electrical conductivity for an electrolytic capacitor, which includes a solvent made of 65% to 100% by weight of water and 35% to 0% by weight of organic solvent and an alkanolamine compound additive. An aluminum electrolytic capacitor using as its electrolyte has low impedance and excellent low-temperature stability and high-temperature prolonged life and shelf life.

### BACKGROUND OF THE INVENTION

1. Field of the Invention

The present invention relates to a high water-containing electrolytic solution for an electrolytic capacitor, which has good low-temperature and high-temperature characteristics and can restrain a pressure uprising inside the electrolytic capacitor at a higher temperature.

2. Description of Related Art

Various applications of capacitors include home appliances, computer motherboards and peripherals, power supplies, communication products and automobiles. The capacitors are mainly used to provide filtering, bypassing, rectifying, coupling, blocking or transforming function, which play an important role in the electric and electronic products. There are different capacitors, such as aluminum electrolytic capacitors, tantalum electrolytic capacitors or laminated ceramic capacitors, in different utilization. The present invention is focused on the aluminum electrolytic capacitor.

A typical aluminum electrolytic capacitor includes an anode foil and a cathode foil processed by surface-enlargement and/or formation treatments. The surface-enlargement treatment is performed by etching a high purity aluminum foil to increase its surface area so that a high capacitance can be obtained to achieve miniaturized electrolytic capacitor. The anode aluminum foil is then subjected to the formation treatment to form a dielectric surface film. A thickness of the dielectric film is related to a supply voltage of the electrolytic capacitor. Normally the cathode foil will be subjected to the formation treatment, too. However, if no formation treatment on the cathode foil, an oxide film layer will be still formed on the surface when exposed in the air. After cutting to a specific size according to design spec., a laminate made up of the anode foil, the cathode foil which is opposed to the dielectric film of the anode foil and has etched surfaces, and a separator interposed between the anode and cathode foils, is wound to provide an element. The wound element does not have any electric characteristic of the electrolytic capacitor yet until completely dipped in an electrolytic solution for driving and housed in a metallic sheathed package in cylindrical form with a closed-end equipping a releaser. Furthermore, a sealing member made of elastic rubber is inserted into an open-end section of the sheathed package, and the open-end section of the sheathed package is sealed by drawing, whereby an aluminum electrolytic capacitor is constituted.

In fact, the electrolytic capacitor utilizes the mobility of ions in the electrolytic solution to obtain an electric circuit; therefore, the electrical conductivity of the electrolytic solution is an important factor for deciding performance of the electrolytic capacitor. Such that, it is an issue for how to promote the electrical conductivity of the electrolytic solution to maintain the electrolytic capacitor with high-temperature stability on the solution, the aluminum foils, the separator and etc., especially the stability of the solution and the aluminum foils. A typical electrolytic solution for a conventional electrolytic capacitor, especially for those electrolytic capacitors work on a supply voltage under 100V, includes water, organic solvent, organic acid, inorganic acid and some special additives mixed in different proportions.

As in U.S. Pat. No. 6,288,889, the water (one solvent of the electrolytic solution) is easily to react with the aluminum foils; therefore, the generation of hydrogen will raise the inner pressure stressing on the electrolytic capacitor to cause damage or the releaser being activated to discharge the electrolytic solution.

The above-mentioned reaction of water and hydrogen can be controlled by adding chemicals. As in Taiwanese patent publication No. 573307, an electrolytic solution includes a solvent composed of 10-80 wt % of an organic solvent and 90-20 wt % water and at least one electrolyte selected from the group consisting of carboxylic acids or their salts and inorganic acids or their salts. This addition of a compound with an unsaturated bond-containing chain serves to absorb hydrogen gas.

As in another U.S. Pat. No. 6,493,211, an electrolytic solution is disclosed, in which a compound forming a phosphate ion in an aqueous solution and a chelating agent are added to the solvent containing mainly water to form a combined product of water-soluble aluminum complex and a phosphate ion.

It can be realized that a high water-containing electrolytic solution which even contains water as the only solvent for the aluminum electrolytic capacitor is doable by well controlling the chemical stability with the aluminum foil electrodes. In addition, water has the advantages as follows.

1. As a protonic polar solvent, water is easy to form hydrogen bonds and can produce large amount of ions during ionization to promote the electrical conductivity of the electrolytic solution.

2. Water has low viscosity and good impregnation with the aluminum foils and separator to reduce impregnating time.

3. Water is cheaper and affordable.

On the contrary, water has the disadvantages as follows.

1. With lower boiling point and higher saturated vapor tension, the pressure inside the electrolytic capacitor may be too high to cause damage on the capacitor structure.

2. At high temperature, water may react with the aluminum oxide to form hydroxide and hydrogen so that the dielectric film may be destroyed to cause rapid decent on voltage endurance and ascent on leakage current.

3. Because of high water containing, the low-temperature characteristics of the electrolytic solution may be no good.

Moreover, under the environmental concerns, many former used chemicals for the electrolytic solution to attain low resistance so that the electrolytic capacitor can have a low impedance are forbidden. Therefore, it is also an issue to pursue a substitutive low toxic electrolytic solution with high electrical conductivity.

Although to promote the electrical conductivity of the electrolytic solution is not the only way to realize the electrolytic capacitor with low impedance, other approaches such as improving the separator or increasing the electrode area may be unsatisfactory. For example, a low-density separator will increase the risk of short circuit. On the other hand, in view of miniaturization, a larger aluminum foil is unacceptable. Therefore, particularly in smaller capacitors, the specific conductivity of the electrolytic solution is a predominant factor for impedance.

### SUMMARY OF THE INVENTION

The present invention utilizes the advantages of water to provide a high water-containing electrolytic solution for the aluminum electrolytic capacitor. By solving the disadvantages of water to the electrolytic solution, the low-temperature and high-temperature characteristics of the electrolytic solution are significantly improved. Such that, an aluminum electrolytic capacitor using as its electrolytic solution has low impedance, excellent low-temperature stability and high-temperature prolonged life and shelf life. Meanwhile, the electrolytic solution can meet the environmental requirements.

Accordingly, the present invention provides a high water-containing electrolytic solution for an electrolytic capacitor, which includes a solvent made of 65% to 100% by weight of water and 35% to 0% by weight of organic solvent and an alkanolamine compound additive.

The above summaries are intended to illustrate exemplary embodiments of the invention, which will be best understood in conjunction with the detailed description to follow, and are not intended to limit the scope of the appended claims.

### DETAILED DESCRIPTION OF THE INVENTION

A high water-containing electrolytic solution for an electrolytic capacitor of the present invention includes a solvent made of 65% to 100% by weight of water and 35% to 0% by weight of organic solvent. By adding an additional alkanolamine compound, the low-temperature and high-temperature characteristics of the electrolytic solution are significantly improved, However, due to the high water-containing rate, an appropriate supply voltage for an electrolytic capacitor using the same will be dropped to less than 100V, especially suitable for a supply voltage less than 50V.

The above-mentioned electrolytic solution contains mainly water as its solvent. A weight percentage of the water with respect to the electrolytic solution is 50˜85 wt %. Moreover, the electrolytic solution includes 10˜45 wt % organic acids and their salts or inorganic acids and their salts, 0.1˜3 wt % hydrogen-absorbing agent and 0.1˜10 wt % alkanolamine compound additive.

The solvent of the electrolytic solution according to the present invention can be chosen from the groups including water, benzalcohol, ethylene glycol, diethylene glycol, 1,2-propylene glycol, 1,3-propylene glycol, 2-methoxyethanol (ethylene glycol monomethyl ether), 2-ethoxyethanol (ethylene glycol monoethyl ether), ethyeneglycol monopropyl ether, butyldiglycol (ethyeneglycol monobutyl ether), ethylene glycol dimethyl ether, ethylene glycol diethyl ether, ethyeneglycol dibutyl ether, glycerine and the likes. Preferably the solvent of the electrolytic solution uses water and ethylene glycol.

The solute of the electrolytic solution is for increasing the electrical conductivity, which can includes organic acids and their salts and inorganic acids and their salts. The organic acids and their salts can be chosen from the groups including formic acid, acetic acid, propionic acid, butyric/ethyl acetic acid, hexanoic acid, octanoic acid (2-EH acid, nonanoic acid, oxalic acid, malonic acid, succinic acid, adipic acid, pimelic acid, suberic acid (octanedioic, azelaic acid, secanoic acid, 1,12 dodecanediol, succinic acid, critic acid, furmaric acid, maleic acid, salicylic acid, benzoid acid, phenylacetic acid, o-phethalic acid, terephthalic acid and the likes, and their salts including ammonium salt, sodium salt and potassium salt. The inorganic acids and their salts can be chosen from the groups including boric acid, ammonium pentaborat, phosphoric acid, phosphorous acid, hypophosphorous acid, phosphotungstate and the likes, and their salts including ammonium salt, sodium salt and potassium salt.

The hydrogen-absorbing agent is for eliminate the hydrogen gas generated from operating the capacitor to reduce the inner pressure thereof. The hydrogen-absorbing agent is a compound including nitryl such as p-nitrophenol, m-nitrophenol, o-nitrophenol, p-nitrobenzoic acid, o-nitrobenzoic acid, m-nitrobenzoic acid, p-nitro anisole, m-nitro anisole, o-nitro anisole, dithiobis nitrobenzoic acid, nitro-acetophenone, nitroaniline and the likes.

The additional additive is to enhance the electrolytic solution with excellent low-temperature stability and high-temperature shelf life and load life. This additive can be represent as follows.
N—(R₁)(R₂)(R₃)

Where at least one R₁, R₂ or R₃ is chosen from the groups including methoxyl, ethoxyl, propanoxyl, and isopropanoxyl, and others are chosen from the groups including hydryl, alkylalkyl and benzene. For example, the alkanolamine compound additive of the present invention includes primary amine such as monoethanolamine, diethanolamine, secondary amine such as diisopropanolamine, N-phenyldiethanolamine, and tertiary amine such as triethanolamine.

In present invention, the above-mentioned compounds can be chosen to be mixed in the solvent system in any sequence by stirring at a temperature about 30 to about 80° C. After the chemical compounds are thoroughly dissolved, the electrolytic solution of the present invention is prepared.

### EXAMPLES

The present invention will be described in detail with reference to below preferred examples 1 to 5 and comparative examples 1 to 3. The prepared electrolytic solution is 5 individually measured the electrical conductivity (mS/cm) at 25° C., as listed in Table II.

The electrolytic capacitor made from each electrolytic solution of the preferred examples 1-5 or comparative examples 1-3 is compared with conventional electrolytic capacitors of comparative examples 4 and 5 by the impedance (Z), capacitance (C) and tangent of dielectric loss (tan δ) at 120 Hz in a ratio measured at low temperature (−20° C., −30° C.) with respect to 20° C. The results are listed in Table III.

In order to evaluate the characteristics of the high-temperature load life and shelf life, each characteristic of the electrolytic solutions in the preferred examples 1-5 and comparative examples 1-3, such as capacitance, tan δ, and leakage current and impedance at 100 kHz at initial, and a change rate of capacitance and other characteristic after 2000 and 3000 hours at 105° C. or 125° C. are listed in Table IV to VII, respectively.

The present invention uses a capacitor with 6.3V, 1000 μF, 8 mm×20 mm (radius×height) for the example. The capacitor includes: (1) the anode aluminum foil, model LA80A1, capacitance per unit 65 μF/cm2, 11.5AV, 119 mm×14 mm (long×width) produced by Li4Dwen company, Taiwan; (2) the cathode aluminum foil, model FT520, capacitance per unit 200 μF/cm2, 134 mm×14 mm (long×width) produced by Hong2Hwa2 company, Taiwan; (3) the separator, model RTZ30-40, 40 μm (thickness), 288 mm×16 mm (long×width) produced by NKK company, Japan. A load life test and a shelf life test are performed to measure the electric characteristics of the aluminum electrolytic capacitor at a specific temperature, such as 105° C. and 125° C. in the preferred embodiments, with or without applying a predetermined voltage after a specific time period, respectively and then cool down to a room temperature.

### Preferred Example 1

Take ethylene glycol (EG) for 109.6 grams and deionized water (>10MΩ-cm) for 204.4 grams to put in a breaker for mixing by stirring. After 5 minutes of heating, add ammonium adipate (AAd) for 48.4 grams, ammonium formate (AF) for 15.2 grams, citric acid (CA) for 2.8 grams, p-nitrobenzoic acid (PNBA) for 4.0 grams, ammonium phosphate, monobasic (AmP) for 12.0 grams and triethanolamine (TEA) for 3.2 grams into the solvent of EG and water. Until fully dissolving, stop heating and stirring and put the solution into a container for later use after sealing. Measure the electrical conductivity of the solution as listed in Table II.

### Preferred Examples 2

Take EG for 42.2 grams and deionized water for 266.0 grams to put in a breaker for mixing by stirring. After 5 minutes of heating, add AAd for 44.8 grams, AF for 23.2 grams, CA for 2.4 grams, PNBA for 2.8 grams, AmP for 10.4 grams and TEA for 8 grams into the solvent of EG and water. Until fully dissolving, stop heating and stirring and put the solution into a container for later use after sealing. Measure the electrical conductivity of the solution as listed in Table II.

### Preferred Example 3

Take EG for 25.6 grams and deionized water for 282.4 grams to put in a breaker for mixing by stirring. After 5 minutes of heating, add AAd for 38 grams, AF for 32 grams, CA for 4 grams, PNBA for 4.8 grams, AmP for 9.2 grams and TEA for 4 grams into the solvent of EG and water. Until fully dissolving, stop heating and stirring and put the solution into a container for later use after sealing. Measure the electrical conductivity of the solution as listed in Table II.

### Comparative Example 1

Take EG for 26.8 grams and deionized water for 285.2 grams to put in a breaker for mixing by stirring. After 5 minutes of heating, add AAd for 38 grams, AF for 32 grams, CA for 4 grams, PNBA for 4.8 grams and AmP for 9.2 grams into the solvent of EG and water. Until fully dissolving, stop heating and stirring and put the solution into container for later use after sealing. Measure the electrical conductivity of the solution as listed in Table II.

### Preferred Example 4

Take EG for 17.2 grams and deionized water for 290.4 grams to put in a breaker for mixing by stirring. After 5 minutes of heating, add AAd for 38.4 grams, AF for 30.8 grams, CA for 2.8 grams, PNBA for 7.6 grams, AmP for 9.2 grams and TEA for 4.4 grams into the solvent of EG and water. Until fully dissolving, stop heating and stirring and put the solution into container for later use after sealing. Measure the electrical conductivity of the solution as listed in Table II.

### Comparative Example 2

Take EG for 18.8 grams and deionized water for 292.4 grams to put in a breaker for mixing by stirring. After 5 minutes of heating, add AAd for 38.4 grams, AF for 30.8 grams, CA for 2.8 grams, PNBA for 7.6 grams and AmP for 9.2 grams into the solvent of EG and water. Until fully dissolving, stop heating and stirring and put the solution into container for later use after sealing. Measure the electrical conductivity of the solution as listed in Table II.

### Preferred Example 5

Take deionized water for 307.6 grams to put in a breaker for stirring. After 5 minutes of heating, add AAd for 39.2 grams, AF for 30.0 grams, CA for 3.2 grams, PNBA for 6.0 grams, AmP for 10.0 grams and TEA for 5.6 grams into the solvent of water. Until fully dissolving, stop heating and stirring and put the solution into container for later use after sealing. Measure the electrical conductivity of the solution as listed in Table II.

### Comparative Example 3

Take deionized water for 311.6 grams to put in a breaker for stirring. After 5 minutes of heating, add AAd for 39.2 grams, AF for 30.0 grams, CA for 3.2 grams, PNBA for 6.0 grams and AmP for 10.0 grams into the solvent of water. Until fully dissolving, stop heating and stirring and put the solution into container for later use after sealing. Measure the electrical conductivity of the solution as listed in Table II.

### Comparative Examples 4 & 5

Comparative Example 4 is chosen from one Japanese aluminum electrolytic capacitor of extra low impedance for comparison, with size and specification of 6.3V-1500 μF, 8øx20L.

Comparative Example 5 is chosen from another Japanese aluminum electrolytic capacitor of extra low impedance for comparison, with size and specification of 16V-1500 μF, 10øx20L.

Table I shows each solvent constitution by weight of all preferred examples and comparative examples 1-3.

The preferred examples 1-5 include an alkanolamine compound additive of the present invention, while the comparative examples 1-3 are for contrast and comparative examples 4-5 come from existed marketing aluminum electrolytic capacitors. The comparison of low-temperature characteristics are listed in Table III to show the ratio of capacitance C at −20° C./20° C. and −30° C./20° C., the ratio of tangent of dielectric loss tan δ at −20° C./20° C. and −30° C./20° C., and the ratio of impedance Z at −20° C./20° C. and −30° C./20° C. The results show the alkanolamine compound additive can significant improve the low-temperature characteristics including Z, C and tan δ of the electrolytic capacitor.

The alkanolamine compound additive of the present invention distinctly enhances the low-characteristics of a high water-containing electrolytic capacitor. As shown in Table III, with same proportion of constitutions in the solvent as in preferred example 3 corresponding to comparative example 1, preferred example 4 corresponding to comparative example 2, and preferred example 5 corresponding to comparative example 3, the low-characteristics of Z, C and tanδ at the frequency of 120 Hz are improved. Even in the preferred example 5 without organic solvent, the performance of each low-temperature characteristic is better than the existed capacitors of the comparative examples 4 and 5. In addition, the present invention has excellent performance at high-temperature tests as described below.

From the results of the load life tests of Table IV at 105° C. and of Table V at 125° C., and the shelf life tests of Table VI at 105° C. and of Table VII at 125° C., it can be obviously seen the alkanolamine compound additive of the present invention also distinctly enhances the high-characteristics of a high water-containing electrolytic capacitor. Comparing Table IV to Table VII, the preferred examples 1-5 including the alkanolamine compound additive still have good high-temperature electric characteristics even after 3000 hours test at 125° C. However, on the contrary, the comparative examples 1-3 without adding the alkanolamine compound result in invalidity of the capacitors.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

TABLE I
Solvent constitution by weight

| | | | | Comparative | | Comparative | | Comparative |
|---|---|---|---|---|---|---|---|---|
| | Example 1 | Example 2 | Example 3 | Example 1 | Example 4 | Example 2 | Example 5 | Example 3 |
| Ethylene | 34.9% | 13.7% | 8.3% | 8.6% | 5.6% | 6.0% | 0 | 0 |
| Glycol | | | | | | | | |
| Pure | 65.1% | 86.3% | 91.7% | 91.4% | 94.4% | 94.0% | 100% | 100% |
| Water | | | | | | | | |

TABLE II
Electrolytic solution constitution (wt %) and electrical conductivity

| | Water | EG | AAd | AF | CA | PNBA | AmP | TEA | mS/cm (25° C.) |
|---|---|---|---|---|---|---|---|---|---|
| Example 1 | 51.1 | 27.4 | 12.2 | 3.8 | 0.7 | 1.0 | 3.0 | 0.8 | 55.3 |
| Example 2 | 66.5 | 10.6 | 11.2 | 5.8 | 0.6 | 0.7 | 2.6 | 2.0 | 76.0 |
| Example 3 | 70.6 | 6.4 | 9.5 | 8.0 | 1.0 | 1.2 | 2.3 | 1.0 | 88.1 |
| Comparative | 71.3 | 6.7 | 9.5 | 8.0 | 1.0 | 1.2 | 2.3 | — | 89.9 |
| Example 1 | | | | | | | | | |
| Example 4 | 72.6 | 4.3 | 9.6 | 7.6 | 0.6 | 1.9 | 2.3 | 1.1 | 98.7 |
| Comparative | 73.1 | 4.7 | 9.6 | 7.7 | 0.7 | 1.9 | 2.3 | — | 101.2 |
| Example 2 | | | | | | | | | |
| Example 5 | 76.9 | — | 9.8 | 7.4 | 0.8 | 1.2 | 2.5 | 1.4 | 110.0 |
| Comparative | 77.9 | — | 9.8 | 7.5 | 0.8 | 1.5 | 2.5 | — | 111.3 |
| Example 3 | | | | | | | | | |

EG: ethylene glycol, CAS: 107-21-1
AAd: ammonium adipate, CAS: 3385-41-9
AF: Ammonium formate, CAS: 540-69-2
CA: citric acid, CAS: 77-92-9
PNBA: p-nitrobenzoic acid, CAS: 62-23-7
AmP: ammonium phosphate, monobasic, CAS: 7722-79-1
TEA: triethanolamine, CAS: 102-71-6

TABLE III
Comparison of low-temperature characteristic

| | −20° C. | | | −30° C. | | |
|---|---|---|---|---|---|---|
| | | | 120 Hz, | | | 120 Hz, |
| | 120 Hz, Z | 120 Hz, C | tan δ | 120 Hz, Z | 120 Hz, C | tan δ |
| | −20/20° C. | −20/20° C. | −20/20° C. | −30/20° C. | −30/20° C. | −30/20° C. |
| Example 1 | 1.03 | 95.9% | 1.13 | 1.07 | 90.3% | 1.78 |
| Example 2 | 1.09 | 91.4% | 1.11 | 1.14 | 86.5% | 2.79 |
| Example 3 | 1.09 | 91.5% | 1.15 | 1.18 | 81.9% | 4.66 |
| Comparative | 1.06 | 94.1% | 1.23 | 1.16 | 82.4% | 7.76 |
| Example 1 | | | | | | |
| Example 4 | 1.10 | 91.2% | 1.05 | 1.34 | 67.6% | 8.61 |
| Comparative | 1.05 | 94.8% | 1.17 | 2.17 | 30.2% | 30.38 |
| Example 2 | | | | | | |
| Example 5 | 1.09 | 91.8% | 1.04 | 1.79 | 45.4% | 13.98 |
| Comparative | 1.06 | 96.5% | 1.19 | 4.28 | 9.40% | 58.07 |
| Example 3 | | | | | | |
| Comparative | 1.39 | 71.4% | 0.90 | 4.20 | 11.3% | 16.62 |
| Example 4 | | | | | | |
| Comparative | 1.31 | 76.2% | 1.41 | 3.62 | 14.1% | 25.07 |
| Example 5 | | | | | | |

Comparative Example 4: choose from Japanese aluminum electrolytic capacitor of extra low impedance for comparison, with size and specification of 6.3 V-1500 μF, 8Ø × 20 L.
Comparative Example 5: choose from Japanese aluminum electrolytic capacitor of extra low impedance for comparison, with size and specification of 16 V-1500 μF, 10Ø × 20 L.
Note 1:
120 Hz, Z, −20/20° C.: at frequency 120 Hz, temperature −20 and 20° C., a ratio of Z
Note 2:
120 Hz, C, −20/20° C.: at frequency 120 Hz, temperature −20 and 20° C., a ratio of C
Note 3:
120 Hz, tan δ, −20/20° C.: at frequency 120 Hz, temperature −20 and 20° C., a ratio of tan δ
Note 4:
120 Hz, Z, −30/20° C.: at frequency 120 Hz, temperature −30 and 20° C., a ratio of Z
Note 5:
120 Hz, C, −30/20° C.: at frequency 120 Hz, temperature −30 and 20° C., a ratio of C
Note 6:
120 Hz, tan δ, −30/20° C.: at frequency 120 Hz, temperature −30 and 20° C., a ratio of tan δ

TABLE IV
Load life test at 105° C.

| | | | | | 105° C., load for 2000 hours | | | | 105° C., load for 3000 hours | | | | |
|---|---|---|---|---|---|---|---|---|---|---|---|---|---|
| | Initial characteristic | | | | Capacitance | | | | Capacitance | | | | |
| | | | Leakage | | change | | Leakage | | change | | Leakage | 100 | |
| | Capacitance | tan δ | current | 100 kHz Z | rate | tan δ | current | 100 kHz Z | rate | tan δ | current | kHz Z | |
| | (μF) | (%) | (μA) | (Ω) | (μF) | (%) | (μA) | (Ω) | (μF) | (%) | (μA) | (Ω) | Outline |
| Example 1 | 918.6 | 4.77 | 3.0 | 0.014 | −8.39 | 5.93 | 1.8 | 0.015 | −9.32 | 6.21 | 2.0 | 0.015 | Good |
| Example 2 | 914.0 | 4.47 | 2.4 | 0.012 | −8.89 | 5.62 | 2.2 | 0.013 | −8.83 | 6.00 | 1.6 | 0.012 | Good |
| Example 3 | 921.1 | 4.34 | 2.1 | 0.011 | −8.25 | 5.35 | 2.3 | 0.012 | −8.16 | 5.71 | 1.5 | 0.012 | Good |
| Example 4 | 904.3 | 4.55 | 2.3 | 0.011 | −8.59 | 6.03 | 1.9 | 0.012 | −8.32 | 6.68 | 1.4 | 0.012 | Good |
| Example 5 | 917.8 | 4.23 | 2.4 | 0.010 | −8.53 | 5.45 | 1.9 | 0.011 | −8.24 | 5.87 | 1.1 | 0.011 | Good |

| | | | | | |
|---|---|---|---|---|---|
| Comparative | 888.6 | 4.60 | 2.0 | 0.012 | The electrolytic capacitor is invalid within 500 hours, and the releaser is activated. |
| Example 1 | | | | | |
| Comparative | 910.3 | 4.34 | 2.3 | 0.011 | The electrolytic capacitor is invalid within 500 hours, and the releaser is activated. |
| Example 2 | | | | | |
| Comparative | 905.6 | 4.41 | 2.0 | 0.010 | The electrolytic capacitor is invalid within 500 hours, and the releaser is activated. |
| Example 3 | | | | | |

Condition:
1. All measured at room temperature.
2. Frequency: capacitance at 120 Hz, tan δ at 120 Hz, leakage current after charging two mins. by a supply voltage of 6.3 V, impedance Z at 100 Hz.

TABLE V
Load life test at 125° C.

| | | | | | 125° C., load for 2000 hours | | | | 125° C., load for 3000 hours | | | | |
|---|---|---|---|---|---|---|---|---|---|---|---|---|---|
| | Initial characteristic | | | | Capacitance | | | | Capacitance | | | | |
| | | | Leakage | | change | | Leakage | | change | | Leakage | 100 | |
| | Capacitance | tan δ | current | 100 kHz Z | rate | tan δ | current | 100 kHz Z | rate | tan δ | current | kHz Z | |
| | (μF) | (%) | (μA) | (Ω) | (μF) | (%) | (μA) | (Ω) | (μF) | (%) | (μA) | (Ω) | Outline |
| Example 1 | 919.7 | 4.90 | 2.4 | 0.014 | −15.75 | 8.35 | 1.8 | 0.018 | −17.98 | 9.35 | 1.6 | 0.024 | Good |
| Example 2 | 911.8 | 4.52 | 2.3 | 0.012 | −15.61 | 8.70 | 1.9 | 0.016 | −18.01 | 10.28 | 1.0 | 0.019 | Good |
| Example 3 | 921.1 | 4.34 | 2.1 | 0.011 | −15.56 | 7.86 | 1.7 | 0.015 | −17.37 | 9.42 | 1.5 | 0.017 | Good |
| Example 4 | 904.3 | 4.55 | 2.3 | 0.011 | −15.03 | 7.82 | 1.7 | 0.016 | −16.81 | 8.93 | 1.6 | 0.019 | Good |
| Example 5 | 917.8 | 4.23 | 2.4 | 0.010 | −15.14 | 7.49 | 2.1 | 0.012 | −16.68 | 8.57 | 1.4 | 0.014 | Good |

| | | | | | |
|---|---|---|---|---|---|
| Comparative | 888.6 | 4.60 | 2.0 | 0.012 | The electrolytic capacitor is invalid within 250 hours, and the releaser is activated. |
| Example 1 | | | | | |
| Comparative | 910.3 | 4.34 | 2.3 | 0.011 | The electrolytic capacitor is invalid within 250 hours, and the releaser is activated. |
| Example 2 | | | | | |
| Comparative | 905.6 | 4.41 | 2.0 | 0.010 | The electrolytic capacitor is invalid within 250 hours, and the releaser is activated. |
| Example 3 | | | | | |

Condition:
1. All measured at room temperature.
2. Frequency: capacitance at 120 Hz, tan δ at 120 Hz, leakage current after charging two mins. by a supply voltage of 6.3 V, impedance Z at 100 Hz.

TABLE VI
Shelf life test at 105° C.

| | | | | | 105° C., deposit for 2000 hours | | | | 105° C., deposit for 3000 hours | | | | |
|---|---|---|---|---|---|---|---|---|---|---|---|---|---|
| | Initial characteristic | | | | Capacitance | | | | Capacitance | | | | |
| | | | Leakage | | change | | Leakage | | change | | Leakage | 100 | |
| | Capacitance | tan δ | current | 100 kHz Z | rate | tan δ | current | 100 kHz Z | rate | tan δ | current | kHz Z | |
| | (μF) | (%) | (μA) | (Ω) | (μF) | (%) | (μA) | (Ω) | (μF) | (%) | (μA) | (Ω) | Outline |
| Example 1 | 917.4 | 4.83 | 1.8 | 0.014 | −10.54 | 6.11 | 19.7 | 0.015 | −11.65 | 6.82 | 29.3 | 0.016 | Good |
| Example 2 | 904.5 | 4.73 | 2.5 | 0.012 | −11.49 | 6.10 | 20.9 | 0.013 | −11.31 | 6.51 | 25.6 | 0.013 | Good |
| Example 3 | 921.1 | 4.34 | 2.1 | 0.011 | −10.77 | 5.72 | 23.9 | 0.012 | −10.61 | 6.12 | 23.7 | 0.012 | Good |
| Example 4 | 904.3 | 4.55 | 2.3 | 0.011 | −10.45 | 6.03 | 18.9 | 0.012 | −10.51 | 6.41 | 21.7 | 0.012 | Good |
| Example 5 | 917.8 | 4.23 | 2.4 | 0.010 | −10.09 | 5.38 | 15.9 | 0.011 | −10.37 | 5.64 | 28.9 | 0.011 | Good |

| | | | | | |
|---|---|---|---|---|---|
| Comparative | 888.6 | 4.60 | 2.0 | 0.012 | The electrolytic capacitor is invalid within 500 hours, and the releaser is activated. |
| Example 1 | | | | | |
| Comparative | 910.3 | 4.34 | 2.3 | 0.011 | The electrolytic capacitor is invalid within 500 hours, and the releaser is activated. |
| Example 2 | | | | | |
| Comparative | 905.6 | 4.41 | 2.0 | 0.010 | The electrolytic capacitor is invalid within 500 hours, and the releaser is activated. |
| Example 3 | | | | | |

Condition:
1. All measured at room temperature.
2. Frequency: capacitance at 120 Hz, tan δ at 120 Hz, leakage current after charging two mins. by a supply voltage of 6.3 V, impedance Z at 100 Hz.

TABLE VII
Shelf life test at 125° C.

| | | | | | 125° C., deposit for 2000 hours | | | | 125° C., deposit for 3000 hours | | | | |
|---|---|---|---|---|---|---|---|---|---|---|---|---|---|
| | Initial characteristic | | | | Capacitance | | | | Capacitance | | | | |
| | | | Leakage | 100 | change | | Leakage | 100 | change | | Leakage | 100 | |
| | Capacitance | tan δ | current | kHz Z | rate | tan δ | current | kHz Z | rate | tan δ | current | kHz Z | |
| | (μF) | (%) | (μA) | (Ω) | (μF) | (%) | (μA) | (Ω) | (μF) | (%) | (μA) | (Ω) | Outline |
| Example 1 | 914.0 | 4.72 | 2.6 | 0.014 | −15.73 | 7.88 | 39.4 | 0.019 | −16.72 | 10.10 | 73.6 | 0.026 | Good |
| Example 2 | 911.2 | 4.48 | 2.4 | 0.012 | −15.23 | 7.81 | 45.9 | 0.016 | −15.99 | 9.08 | 56.3 | 0.019 | Good |
| Example 3 | 921.1 | 4.34 | 2.1 | 0.011 | −14.39 | 6.51 | 45.6 | 0.014 | −15.16 | 7.70 | 48.2 | 0.016 | Good |
| Example 4 | 904.3 | 4.55 | 2.3 | 0.011 | −15.26 | 8.40 | 41.9 | 0.014 | −15.80 | 9.52 | 55.1 | 0.018 | Good |
| Example 5 | 917.8 | 4.23 | 2.4 | 0.010 | −13.61 | 7.496.71 | 60.8 | 0.013 | −14.98 | 7.77 | 75.7 | 0.014 | Good |

| | | | | | |
|---|---|---|---|---|---|
| Comparative | 888.6 | 4.60 | 2.0 | 0.012 | The electrolytic capacitor is invalid within 250 hours, and the releaser is activated. |
| Example 1 | | | | | |
| Comparative | 910.3 | 4.34 | 2.3 | 0.011 | The electrolytic capacitor is invalid within 250 hours, and the releaser is activated. |
| Example 2 | | | | | |
| Comparative | 905.6 | 4.41 | 2.0 | 0.010 | The electrolytic capacitor is invalid within 250 hours, and the releaser is activated. |
| Example 3 | | | | | |

Condition:
1. All measured at room temperature.
2. Frequency: capacitance at 120 Hz, tan δ at 120 Hz, leakage current after charging two mins. by a supply voltage of 6.3 V, impedance Z at 100 Hz.

1. A high water-containing electrolyte with higher electrical conductivity for an electrolytic capacitor, the electrolytic solutione comprising a solvent made of 65% to 100% by weight of water and 35% to 0% by weight of organic solvent and an alkanolamine compound additive.

2. The electrolyte of claim 1, wherein the alkanolamine compound additive is as:
N—(R₁)(R₂)(R₃)
wherein at least one R₁, R₂ or R₃ is chosen from the groups including methoxyl, ethoxyl, propanoxyl, and isopropanoxyl, and others are chosen from hydrogen, alkyl and benzyl groups.

3. The electrolyte of claim 2, wherein the alkanolamine compound additive includes primary amine, secondary and tertiary amine.

4. The electrolyte of claim 3, wherein the primary amine is ethanolamine, the secondary amine is diisopropanolamine and the tertiary amine is triethanolamine.

5. The electrolyte of claim 1, wherein the solvent is chosen from the groups including water, benzyl alcohol, ethylene glycol, diethylene glycol, 1,2-propylene glycol, 1,3-propylene glycol, 2-methoxyethanol (ethylene glycol monomethyl ether), 2-ethoxyethanol (ethylene glycol monoethyl ether), ethyeneglycol monopropyl ether, butyldiglycol (ethyeneglycol monobutyl ether), ethylene glycol dimethyl ether, ethylene glycol diethyl ether, ethyeneglycol dibutyl ether and glycerine.

6. The electrolyte of claim 1, further comprising at lease one solute chosen from the groups including organic acids or salts thereof and/or inorganic acids and salts thereof.

7. The electrolyte of claim 6, wherein the organic solute is chosen from the groups including formic acid, acetic acid, propionic acid, butyric acid, hexanoic acid, octanoic acid, nonanoic acid, oxalic acid, malonic acid, succinic acid, adipic acid, pimelic acid, suberic acid, azelaic acid, sebacic acid, dodecanedioic acid, succinic acid, citric acid, furmaric acid, maleic acid, salicylic acid, benzoid acid, phenylacetic add, o-phethalic acid, terephthalic acid, and salts thereof including ammonium salt, sodium salt and potassium salt.

8. The electrolyte of claim 6, wherein the inorganic solute is chosen from the groups including boric acid, ammonium pentaborat, phosphoric acid, phosphorous acid, hypophosphorous acid, phosphotungstate, and salts thereof including ammonium salt, sodium salt and potassium salt.

9. A high water-containing electrolyte with higher electrical conductivity for an electrolytic capacitor, the electrolyte comprising mainly 50˜85 wt % water as a solvent, 10˜45 wt % organic acids and salts or inorganic acids and salts, a 0.1˜3 wt % hydrogen-absorbing agent and a 0.1˜10 wt % alkanolamine compound additive.

10. The electrolyte of claim 9, wherein the alkanolamine compound additive is as:
N—(R₁)(R₂)(R₃)
wherein at least one R₁, R₂ or R₃ is chosen from the groups including methoxyl, ethoxyl, propanoxyl, and isopropanoxyl, and others are chosen from hydrogen, alkyl and benzene groups.

11. The electrolyte of claim 10, wherein the alkanolamine compound additive includes primary amine, secondary, and tertiary amine.

12. The electrolyte of claim 11, wherein the primary amine is ethanolamine, the secondary amine is diisopropanolamine and the tertiary amine is triethanolamine.

13. The electrolyte of claim 9, wherein the solvent is chosen from the groups including water, benzyl alcohol, ethylene glycol, diethylene glycol, 1,2-propylene glycol, 1,3-propylene glycol, 2-methoxyethanol (ethylene glycol monomethyl ether), 2-ethoxyethanol (ethylene glycol monoethyl ether), ethyeneglycol monopropyl ether, butyldiglycol (ethyeneglycol monobutyl ether), ethylene glycol dimethyl ether, ethylene glycol diethyl ether, ethyeneglycol dibutyl ether and glycerine.

14. The electrolyte of claim 9, further comprising at lease one solute chosen from the groups including organic acids or salts thereof and/or inorganic acids and salts thereof.

15. The electrolyte of claim 14, wherein the organic solute is chosen from the groups including formic acid, acetic acid, propionic acid, butyric acid, hexanoic acid, octanoic acid, nonanoic acid, oxalic acid, malonic acid, succinic acid, adipic acid, pimelic acid, suberic acid, azelaic acid, sebacic acid, dodecanedioic acid, succinic acid, citric acid, furmaric acid, maleic acid, salicylic acid, benzoid acid, phenylacetic acid, o-phethalic acid, terephthalic acid, and salts thereof including ammonium salt, sodium salt and potassium salt.

16. The electrolyte of claim 14, wherein the inorganic solute is chosen from the groups including boric acid, ammonium pentaborat, phosphoric acid, phosphorous acid, hypophosphorous acid, phosphotungstate, and salts thereof including ammonium salt, sodium salt and potassium salt.

17. The electrolyte of claim 9, wherein the hydrogen-absorbing agent is a compound including nitro function group.

18. The electrolyte of claim 17, wherein the hydrogen-absorbing compound is chosen from the groups including p-nitrophenol, m-nitrophenol, o-nitrophenol, p-nitrobenzoic acid, o-nitrobenzoic acid, m-nitrobenzoic acid, p-nitro anisole, m-nitroanisole, o-nitroanisole, 2,5-dinitrobenzoic acid, nitro-acetophenone and nitroaniline.
